(19) United States
(12) Patent Application Publication
(10) Pub. No.: US 2007/0285740 A1
(43) Pub. Date: Dec. 13, 2007

(54) Image sensor module

(75) Inventors: Hiroaki Onishi, Kyoto (JP); Hideki Sawada, Kyoto (JP); Hiromi Ogata, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 11/799,106

(22) Filed: Apr. 30, 2007

(30) Foreign Application Priority Data
May 2, 2006 (JP) 2006-128329
Aug. 4, 2006 (JP) 2006-212852
Aug. 7, 2006 (JP) 2006-214603

(51) Int. Cl. H04N 1/04

(52) U.S. Cl. 358/475

(57) ABSTRACT

An image sensor module includes a first substrate, a second substrate, a plurality of light receiving elements mounted on the first substrate, a light source mounted on the second substrate, and a light guide for emitting light from the light source as linear light extending in the primary scanning direction. The light receiving elements are aligned in the primary scanning direction. The second substrate is arranged perpendicularly to the primary scanning direction. The light source includes an LED chip mounted on the second substrate.

### BACKGROUND OF THE INVENTION

1. Field of the Invention

The present invention relates to an image sensor module and an image reader incorporating an image sensor module.

2. Description of the Related Art

An image scanner may be used for reading a document and obtaining the image data. Generally, an image scanner includes a light source, a light guide and a light receiving element and so on. An image sensor module is a unit of these principal structural parts, an example of which is disclosed in JP-A-2004-266313.

FIG. 48 shows the structure of a conventional image sensor module. The image sensor module X1 includes a substrate 401, a light source 402, sensor IC chips 403, a light guide 404, a case 406 and a transparent plate 408. The light guide 404 includes a light incident surface 404a, a light reflecting surface 404b and a light emitting surface 404c.

The light emitted upward from the light source 402 passes through the light incident surface 404a and is then reflected at the light reflecting surface 404b toward the primary scanning direction x. The light exits through the light emitting surface 404c and passes through the transparent plate 408. Then, the light reaches the document. The light reflected by the document passes through a non-illustrated lens array and is then detected by the sensor IC chips 403. However, this conventional structure has a drawback that light is attenuated due to the reflection at the reflection surface 404b.

Another example of conventional image sensor module is disclosed in JP-A-H09-275469. FIG. 49 shows the structure of the image sensor module. The image sensor module X2 shown in the figure includes a substrate 451, a light source 452, a light guide (not shown) and a plurality of sensor IC chips 453. In assembling the image sensor module, the leads 452c of the light source 452 are inserted into terminal holes 451a of the substrate 451 and soldered. With this structure, the light emitted from the light source 452 directly impinges on an end of the light guide in the longitudinal direction. Therefore, unlike the light guide shown in FIG. 48, attenuation of light due to reflection is prevented.

However, the image sensor module X2 has a drawback that the option for the material of the substrate 451 is limited. That is, since the terminal holes 451a need to be formed at the substrate 451, the material of the substrate 451 is limited to those which do not crack in the process of forming holes. Therefore, it is sometimes inevitable to select such a material as glass-fiber-reinforced epoxy resin which has poor heat dissipation ability.

### SUMMARY OF THE INVENTION

The present invention has been proposed under such circumstances. It is, therefore, an object of the present invention to provide an image sensor module which is capable of uniformly emitting light with high luminance and easy to assemble.

According to a first aspect of the present invention, there is provided an image sensor module comprising a first substrate extending in a primary scanning direction; a second substrate including a main surface; a plurality of light receiving elements mounted on the first substrate in a row extending in the primary scanning direction; a light source mounted on the main surface of the second substrate; and a light guide for emitting light from the light source as linear light extending in the primary scanning direction. The main surface of the second substrate is oriented in the primary scanning direction. The light source includes an LED chip mounted on the second substrate.

Preferably, the first substrate and the second substrate are connected to each other via a conductive support member having flexibility.

Preferably, the first substrate has an end close to the second substrate, and the second substrate has an end close to the first substrate, where these two ends are not bonded to the conductive support member.

Preferably, at least one of the first substrate and the second substrate is made of ceramic.

Preferably, the light source includes a reflector surrounding the LED chip.

Preferably, the reflector is made of white resin.

Preferably, the light source includes a light transmitting member covering the LED chip.

Preferably, the light guide is formed, at a portion facing the second substrate, with a recess for accommodating the LED chip.

Preferably, the image sensor module according to the present invention further comprises a case for accommodating the first substrate, the second substrate and the light guide. The case is formed with a reference wall including a surface oriented in the primary scanning direction, and the second substrate is held in contact with the reference wall.

Preferably, the image sensor module according to the present invention further comprises a light shielding member attached to both the case and a surface of the second substrate which is opposite from the main surface.

Preferably, the light shielding member is attached to both the second substrate and the first substrate.

According to a second aspect of the present invention, there is provided a method for manufacturing an image sensor module including a light source, and a plurality of light receiving elements arranged in a primary scanning direction. The method comprises the steps of: attaching a conductive support member having flexibility to a substrate in a manner such that the conductive support member extends across a division target portion extending in a secondary scanning direction perpendicular to the primary scanning direction; and dividing the substrate at the division target portion to obtain a first substrate on which the light receiving elements are mounted and a second substrate on which the light source is mounted.

Preferably, the manufacturing method further comprises the step of directly mounting an LED chip providing the light source on the substrate.

Preferably, the substrate is made of ceramic.

Preferably, the step of attaching the conductive support member includes attaching two anisotropic conductive films to the substrate in parallel with each other on opposite sides of the division target portion, and attaching the conductive support member to the substrate by utilizing the anisotropic conductive films.

Preferably, the method further comprises the step of mounting the first substrate and the second substrate to a case extending in the primary scanning direction. The case is formed with a reference wall including a surface oriented in the primary scanning direction, and the mounting step comprises bringing the second substrate into contact with the reference wall.

Preferably, the mounting step comprises attaching a light shielding member to both the second substrate and the case.

According to a third aspect of the present invention, there is provided an image sensor module comprising a first substrate extending in a primary scanning direction and including opposite ends spaced from each other in the primary scanning direction; a light source; a light guide extending in the primary scanning direction and including a light incident surface facing the light source and a light emitting surface from which light introduced into the light guide through the light incident surface is emitted toward an object to be read as linear light extending in the primary scanning direction; and light receiving sensors arranged on the first substrate along the primary scanning direction for receiving light reflected at the object to be read. The light source includes a second substrate and a light emitting element mounted on the second substrate. The second substrate and the first substrate are fixed to each other via a lead.

Preferably, the lead includes a first end formed with a clip portion, and one of the opposite ends of the first substrate is held by the clip portion.

Preferably, the lead includes a second end which is straight and positioned opposite from the first end. The second substrate includes a terminal provided at an edge thereof, and the terminal comprises a recess formed at the edge and a metal film covering an inner surface of the recess. The second end of the lead is bonded to the terminal.

Preferably, the second substrate is made of a material containing either of glass-fiber-reinforced epoxy resin and polyimide resin.

Preferably, the light emitting element comprises an LED chip die-bonded to the second substrate.

Preferably, the first substrate is made of ceramic.

Preferably, the image sensor module further comprises a case for accommodating the first substrate, the second substrate and the light guide. The case includes a positioning surface for properly positioning the light source in the primary scanning direction and in a direction which is perpendicular to the primary scanning direction.

According to a fourth aspect of the present invention, there is provided an image sensor module comprising: a first substrate which is in the form of an elongated rectangle extending in a primary scanning direction; a light source; a light guide extending in the primary scanning direction and including a light incident surface facing the light source and a light emitting surface from which light introduced into the light guide through the light incident surface is emitted toward an object to be read as linear light extending in the primary scanning direction, the object to be read being moved in a secondary scanning direction relative to the light guide; and light receiving sensors arranged on the first substrate along the primary scanning direction for receiving light reflected at the object to be read. The light source includes a terminal including a portion extending in a direction which is perpendicular to both of the primary scanning direction and the secondary scanning direction. A lead projecting in the primary scanning direction is fixed to the first substrate, and the lead and the terminal of the light source are bonded to each other.

Preferably, the lead includes a straight end soldered to the first substrate.

Preferably, the lead includes a clip-shaped end for holding an end of the first substrate.

Preferably, the lead includes a ring-shaped end for inserting the terminal of the light source.

Preferably, the lead includes a bond end surface to which the terminal of the light source is to be bonded, and the bond end surface is oriented in the primary scanning direction.

Preferably, the first substrate is made of ceramic.

Preferably, the lead comprises part of a wiring formed on a resin base.

Preferably, the image sensor module further comprises a case for accommodating the first substrate, the light source and the light guide. The case includes a space which opens in a direction which is perpendicular to both of the primary scanning direction and the secondary scanning direction, and the light source is accommodated in the space.

### BRIEF DESCRIPTION OF THE DRAWINGS

FIG. 1 is a sectional view showing an image sensor module according to a first embodiment of the present invention.

FIG. 2 is a sectional view taken along lines II-II in FIG. 1.

FIG. 3 is a sectional view showing a principal portion of the image sensor module of FIG. 1.

FIG. 4 is an overall perspective view showing the image sensor module of FIG. 1.

FIG. 5 is a view for describing a method for manufacturing the image sensor module of FIG. 1 and shows a process step of mounting a reflector on a substrate material.

FIG. 6 shows a process step of forming a light transmitting member, which is performed after the process step shown in FIG. 5.

FIG. 7 shows a process step of attaching an anisotropic conductive film to the substrate material, which is performed after the process step shown in FIG. 6.

FIG. 8 shows a process step of mounting a flexible wiring substrate to the substrate material, which is performed after the process step shown in FIG. 7.

FIG. 9 is a sectional view taken along lines IX-IX in FIG. 8.

FIG. 10 shows a process step of dividing the substrate material.

FIG. 11 shows a process step of arranging the longer portion and the shorter portion of the substrate to be perpendicular to each other.

FIG. 12 is a sectional view taken along lines XII-XII in FIG. 11.

FIG. 13 shows a process step of mounting the substrate to a case.

FIG. 14 shows a process step of attaching a light shielding film.

FIG. 15 is a sectional view showing a principal portion of a first variation of the image sensor module according to the first embodiment.

FIG. 16 is a perspective view showing a second variation of the image sensor module according to the first embodiment.

FIG. 17 is a sectional view showing a principal portion of another example of flexible wiring substrate used for the image sensor module of the first embodiment.

FIG. 18 is a perspective view showing another example of the flexible wiring substrate.

FIG. 19 is a perspective view showing another example of the flexible wiring substrate.

FIG. 20 is a sectional view showing a principal portion of an image sensor module according to a second embodiment of the present invention.

FIG. 21 is a sectional view taken along lines II-II in FIG. 20.

FIG. 22 is a perspective view showing a process step of a method for manufacturing a light source used for the image sensor module of FIG. 20.

FIG. 23 is a perspective view showing a principal portion of the image sensor module of FIG. 20.

FIG. 24 is a perspective view showing a principal portion of the image sensor module of FIG. 20.

FIG. 25 is a perspective view showing a first variation of the image sensor module of FIG. 20.

FIG. 26 is a perspective view showing a second variation of the image sensor module of FIG. 20.

FIG. 27 is a perspective view showing a principal portion of the variation shown in FIG. 26.

FIG. 28 is a perspective view showing a third variation of the image sensor module of FIG. 20.

FIG. 29 is a sectional view showing a fourth variation of the image sensor module of FIG. 20.

FIG. 30 is a sectional view showing a principal portion of an image sensor module according to a third embodiment of the present invention.

FIG. 31 is a sectional view taken along lines II-II in FIG. 30.

FIG. 32 is a perspective view showing a light source used for the image sensor module of FIG. 30.

FIG. 33 is a perspective view showing a process step of a method for manufacturing an image sensor module shown in FIG. 30.

FIG. 34 is a perspective view showing a process step of a method for manufacturing an image sensor module shown in FIG. 30.

FIG. 35 is a perspective view showing a process step of a method for manufacturing an image sensor module shown in FIG. 30.

FIG. 36 is a perspective view showing a process step of a method for manufacturing an image sensor module shown in FIG. 30.

FIG. 37 is a perspective view showing a process step of a method for manufacturing an image sensor module shown in FIG. 30.

FIG. 38 is a sectional view showing a first variation of the image sensor module of FIG. 30.

FIG. 39 is a perspective view showing a process step of a method for manufacturing the first variation shown in FIG. 38.

FIG. 40 is a perspective view showing a process step of the method for manufacturing the first variation shown in FIG. 38.

FIG. 41 is a perspective view showing a process step of the method for manufacturing the first variation shown in FIG. 38.

FIG. 42 is a perspective view showing a second variation of the image sensor module of FIG. 30.

FIG. 43 is a perspective view showing a principal portion of a process step of a method for manufacturing the second variation shown in FIG. 42.

FIG. 44 is a perspective view showing a process step of a method for manufacturing a lead used for the image sensor module of FIG. 30.

FIG. 45 is a perspective view showing a process step subsequent to the process step shown in FIG. 44.

FIG. 46 is a perspective view showing another example of lead used for the image sensor module of FIG. 30.

FIG. 47 is a perspective view showing still another example of lead used for the image sensor module of FIG. 30.

FIG. 48 is a sectional view showing an example of conventional image sensor module.

FIG. 49 is a perspective view showing an example of conventional image sensor module.

### DETAILED DESCRIPTION OF THE PREFERRED EMBODIMENTS

Preferred embodiments of the present invention will be described below with reference to the accompanying drawings.

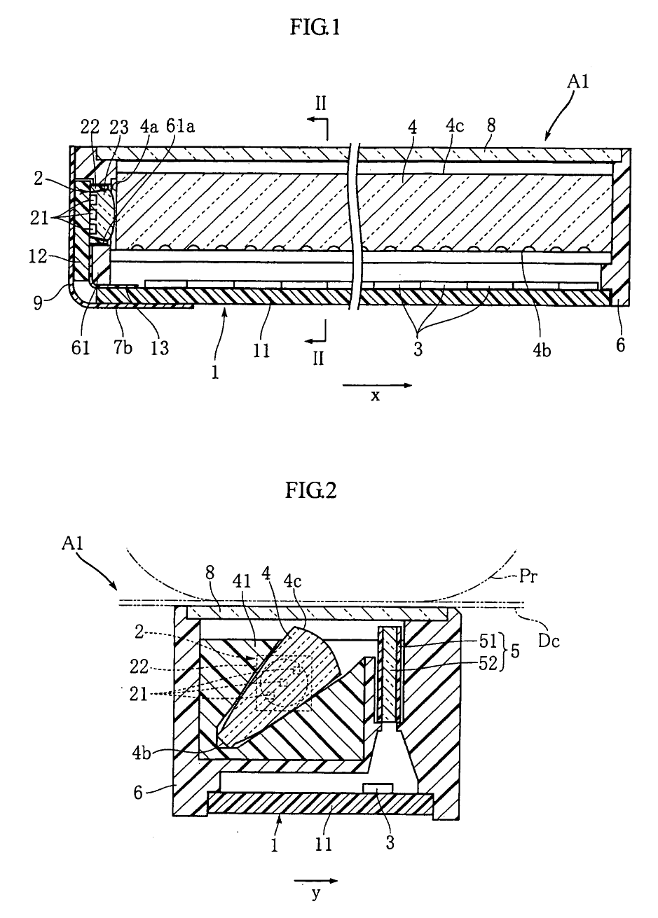

FIGS. 1-4 show an image sensor module A1 according to a first embodiment of the present invention. The image sensor module A1 includes a substrate assembly 1, a light source 2, a plurality of sensor IC chips 3, a light guide 4, a lens array 5, a case 6 and a transparent plate 8. The image sensor module A1 is of a so-called sheet feed type. That is, as shown in FIG. 2, the image sensor module A1 reads a document Dc which is being transferred on the transparent plate 8 in the secondary scanning direction y by e.g. a platen roller Pr.

The substrate assembly 1 shown in FIG. 1 includes a longer substrate 11 and a shorter substrate 12 made of e.g. a ceramic material, and a flexible wiring substrate 13. The longer substrate 11 is mounted to the lower end of the case 6. The shorter substrate 12 is mounted to an end of the case 6 to be perpendicular to the longer substrate 11. The flexible wiring substrate 13 is flexible and includes a metal layer forming a wiring pattern and a plurality of resin layers sandwiching the metal layer.

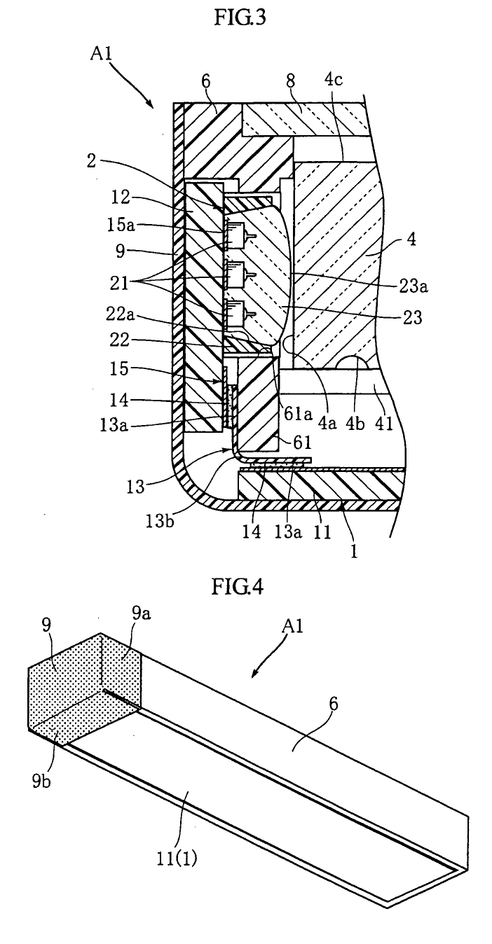

The flexible wiring substrate 13 connects the longer substrate 11 and the shorter substrate 12 to each other. Specifically, as shown in FIG. 3, the flexible wiring substrate 13 includes, at opposite ends thereof, bond portions 13a which are bonded to the longer substrate 11 and the shorter substrate 12, respectively, via anisotropic conductive films 14. The anisotropic conductive films 14 electrically connects the metal layer to the wiring pattern 15 formed on the longer substrate 11 and the shorter substrate 12.

The light source 2 shown in FIG. 3 includes three LED chips 21, a reflector 22 and a light transmitting member 23. The three LED chips 21 may emit red light, green light and blue light, respectively, and are bonded to pads 15a formed on the shorter substrate 12. As shown in FIG. 2, the LED chips 21 are arranged in series along the light emission direction of the light guide 4. The reflector 22 may be made of white resin and surrounds the three LED chips 21. The reflector 22 includes a light reflecting surface 22a. The light emitted from the three LED chips 21 in a direction which is in parallel with the surface of the shorter substrate 12 is reflected at the reflecting surface 22a toward the primary scanning direction x. The light transmitting member 23 may be made of transparent epoxy resin and fills the region surrounded by the reflector 22. The light transmitting member 23 includes a lens surface 23a. The lens surface 23a enhances the directivity of the light emitted from the three LED chips 21.

The sensor IC chips 3 shown in FIG. 1 are semiconductor chips including light receiving portions (not shown). The sensor IC chips 3 are mounted on the longer substrate 11 and so arranged that the light receiving portions are positioned directly below the lens array 5 (See FIG. 2). The sensor IC chips 3 have a photoelectric conversion function and output image signals of a level corresponding to the received amount of light.

The light guide 4 shown in FIG. 1 may be made of polymethyl methacrylate (PMMA) and has high transparency. The light guide 4 includes a light incident surface 4a, alight reflecting surface 4b and a light emitting surface 4c. The light incident surface 4a is a surface for introducing the light emitted from the light source 2 into the light guide 4 and comprises an end surface of the light guide 4 in the primary scanning direction x. To prevent the light from the light source 2 from scattering, the light incident surface 4a is mirror-finished. The light reflecting surface 4b is a surface for reflecting the light traveling from the light incident surface 4a in the primary scanning direction x toward the light emitting surface 4c. The light reflecting surface 4b is formed with a plurality of grooves each extending in the secondary scanning direction y. The light emitting surface 4c is a surface for emitting light toward the document Dc and extends in the primary scanning direction x. As shown in FIG. 2, the light emitting surface 4c is arcuate in section and has a function to converge light at a surface extending perpendicular to the primary scanning direction x. As a result, linear light extending in the primary scanning direction x is emitted from the light emitting surface 4c.

The light guide 4 is mounted to the case 6 via a spacer 41 shown in FIG. 3. The spacer 41 functions to fix the light guide 4 at an appropriate position of the case 6. Thus, the light guide 4 is properly positioned in the primary scanning direction x and the secondary scanning direction y. The spacer 41 may be made of white resin and is formed with an inner space conforming to the sectional configuration of the light guide 4. The spacer 41 reflects the light emitted from a side surface of the light guide 4 to return the light into the light guide 4.

The lens array 5 shown in FIG. 2 converges the light reflected at the document Dc to form a non-inverted, non-magnified image on the sensor IC chips 3. The lens array 5 includes a holder 51 and a plurality of lenses 52. The holder 51 is in the form of a block extending in the primary scanning direction x and may be made of synthetic resin. The lenses 52 are arranged side by side in the primary scanning direction x and held by the holder 51.

The case 6 shown in FIG. 1 is made of synthetic resin and generally in the form of a block extending in the primary scanning direction x. The case 6 accommodates the substrate assembly 1, the light source 2, the sensor IC chips 3, the light guide 4 and the lens array 5. The case 6 is formed, at a lower portion thereof, with a stepped portion, and the longer substrate 11 of the substrate assembly 1 is held in engagement with the stepped portion. Specifically, the longer substrate is pressed against the stepped portion by an elastic member (not shown) made of metal. The case 6 is formed with a reference wall 61 at a portion adjacent to an end thereof in the primary scanning direction x. The reference wall 61 is utilized for properly positioning the shorter substrate 12 in the primary scanning direction x. The reference wall 61 is formed with an opening 61a. The opening 61a is provided at a position facing the light source 2 mounted on the shorter substrate 12 and accommodates part of the light source 2 so that the light from the light source 2 reaches the light incident surface 4a of the light guide 4.

A light shielding film 9 shown in FIG. 4, which may be made of black resin, is bonded to the longer substrate 11, the shorter substrate 12 and the case 6 with e.g. an adhesive. The light shielding film 9 includes opposite side portions 9a bonded to both the shorter substrate 12 and side surfaces of the case 6. The light shielding film 9 further includes a lower portion 9b bonded to both the longer substrate 11 and the shorter substrate 12.

The transparent plate 8 shown in FIG. 1 may be made of transparent glass and is provided at the upper end of the case 6. In use, the document Dc to be read is pressed against the transparent plate 8 by the platen roller Pr and transferred smoothly in the secondary scanning direction y.

An example of method for manufacturing the image sensor module A1 will be described below with reference to FIGS. 5-14.

First, as shown in FIG. 5, a substrate material 1A is prepared. The substrate material 1A is made of a ceramic material and has a size capable of producing five substrate assemblies 1 shown in FIG. 1. The manufacturing method described below is a method for collectively manufacturing five image sensor modules A1 at a time. Unlike this, however, by e.g. preparing the substrate assemblies 1 in advance, the image sensor modules A1 may be manufactured one by one.

For the substrate material 1A, four cutting lines CLx and one cutting line CLy are set. The cutting lines CLx and CLy correspond to four grooves 1Ax and one groove 1Ay formed on the reverse surface of the substrate material 1A, respectively. The grooves 1Ax extend in the direction corresponding to the primary scanning direction x, whereas the groove 1Ay extends in the direction corresponding to the secondary scanning direction y. After a non-illustrated wiring pattern is formed on the obverse surface of the substrate material 1A, a plurality of LED chips 21 and a plurality of sensor IC chips 3 are mounted. The mounting of the LED chips 21 and the sensor IC chips 3 are performed with respect to each of the five regions sectioned by the cutting lines CLx. Reflectors 22 are bonded to the substrate material 1A so that each of the reflectors covers three LED chips 21.

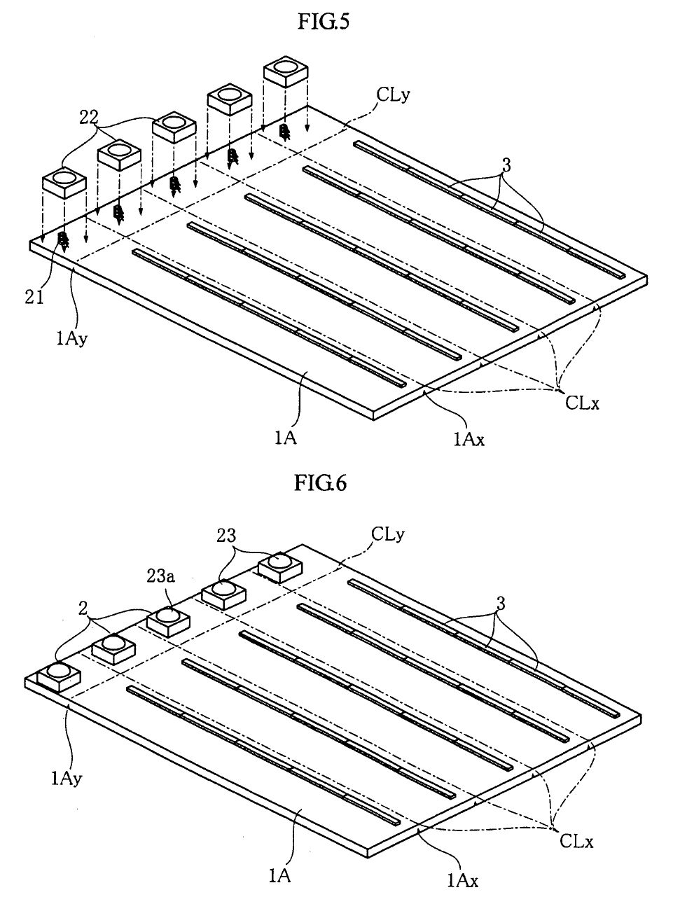

Then, as shown in FIG. 6, potting of e.g. a transparent epoxy resin material is performed with respect to the space surrounded by each of the reflectors 22. By hardening the resin material, a light transmitting member 23 covering the LED chips 21 is formed. By utilizing the surface tension of the resin material, a lens surface 23a which is convexly curved is formed. Instead of the potting, the light transmitting member 23 may be made by a technique using a mold. By forming the light transmitting member 23, the light source 2 is completed.

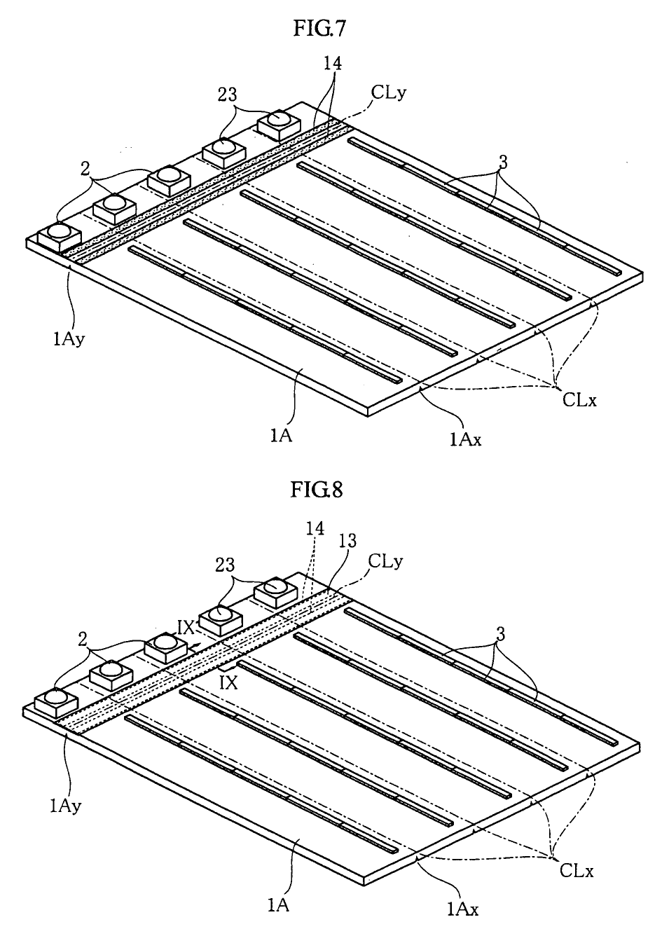

Then, as shown in FIG. 7, two anisotropic conductive films 14 are attached to the substrate material 1A. Specifically, the anisotropic conductive films are attached to extend in parallel with each other, with the cutting line CLy extending therebetween.

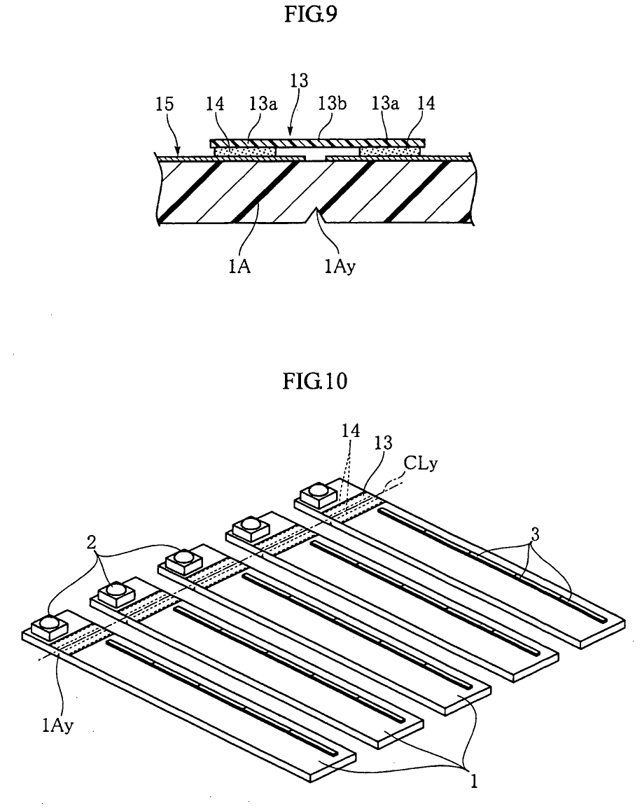

Then, as shown in FIG. 8, a flexible wiring substrate 13 is attached. Specifically, a flexible wiring substrate 13 elongated along the cutting line CLy is placed to cover the two anisotropic conductive films 14. Thus, the flexible wiring substrate 13 is bonded to the substrate material 1A by the two anisotropic conductive films 14. As shown in FIG. 9, the flexible wiring substrate 13 is electrically connected to appropriate portions of the wiring pattern 15 formed on the substrate material 1A via the two anisotropic conductive films 14. Of the flexible wiring substrate 13, two bond portions 13a positioned on the opposite ends are bonded to the substrate material 1A by the anisotropic conductive films 14. The flexible wiring substrate 13 includes, at a portion near the center thereof, a non-bond portion 13b which is not bonded to the substrate material 1A.

Then, the substrate material 1A is cut along the four cutting lines CLx to be divided into five, as shown in FIG. 10. The cutting along the cutting lines CLx is performed by applying a force to bend the substrate material 1A along the grooves 1Ax formed correspondingly to the cutting lines CLx. In this cutting process, the flexible wiring substrate 13 and the anisotropic conductive films 14 are cut together with the substrate material 1A. A cutter, for example, may be used as required.

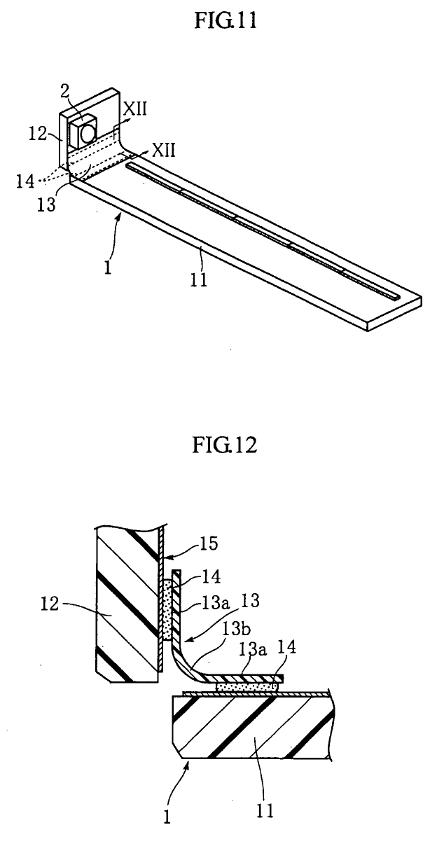

Next, cutting along the cutting line CLy is performed. This cutting is performed by applying a force to bend the substrate material along the groove 1Ay formed correspondingly to the cutting line CLy. In this cutting process, however, the flexible wiring substrate 13 is not cut. As a result, as shown in FIG. 11, the substrate material is divided into a longer substrate 11 and a shorter substrate 12. The longer substrate 11 and the shorter substrate 12 are connected to each other via the flexible wiring substrate 13. Then, the longer substrate 11 and the shorter substrate 12 are oriented to be perpendicular to each other. In this process, as shown in FIG. 12, the flexible wiring substrate 13 is bent mainly at the non-bond portion 13b, so that the flexible wiring substrate 13 is not separated from the longer substrate 11 and the shorter substrate 12.

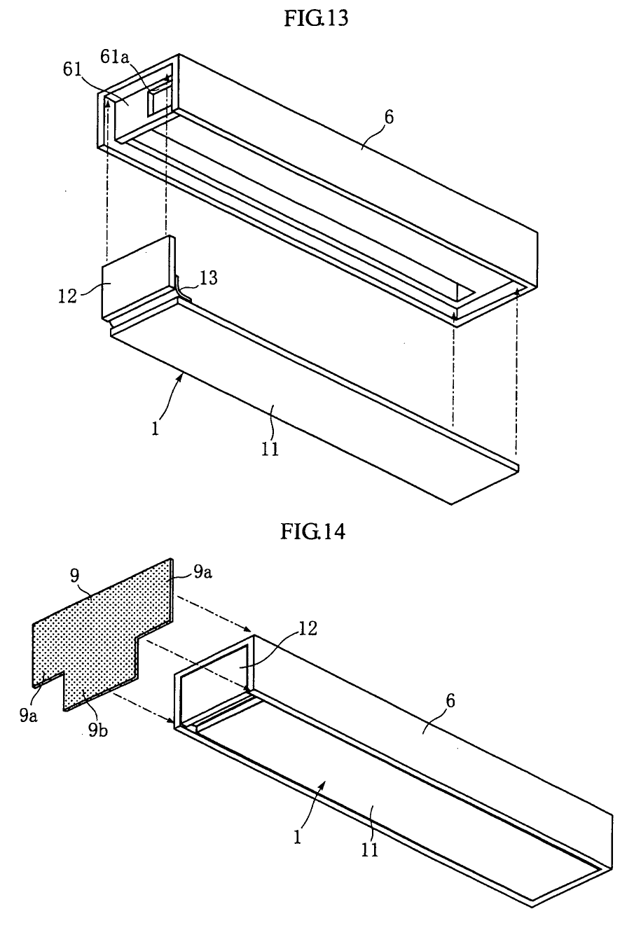

Then, as shown in FIG. 13, a case 6 is prepared. The case 6 may be prepared in advance by using a mold, for example. The shorter substrate 12 is fitted to-the reference wall 61 of the case 6. The light source 2 mounted on the shorter substrate 12 is received in the opening 61a of the reference wall 61. The longer substrate 11 is pressed to fit to the lower side of the case 6.

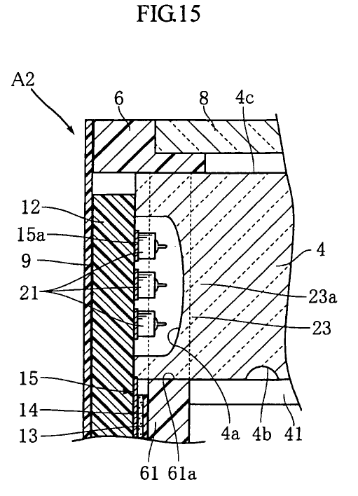

Then, as shown in FIG. 14, a light shielding film 9 is attached to the substrate 1 and the case 6. Specifically, the center portion of the light shielding film 9 is attached to the shorter substrate 12. The opposite sides 9a of the light shielding film 9 are bent to fit to the side surfaces of the case 6. The lower portion 9b of the light shielding film 9 is bent to fit to the longer substrate 11. Thereafter, the processes such as fixing of the longer substrate 11 and mounting of a light guide 4, a lens array 5 and a transparent plate 8 are performed, whereby the image sensor module A1 shown in FIGS. 1-4 is obtained.

The advantages of the image sensor module A1 will be described below.

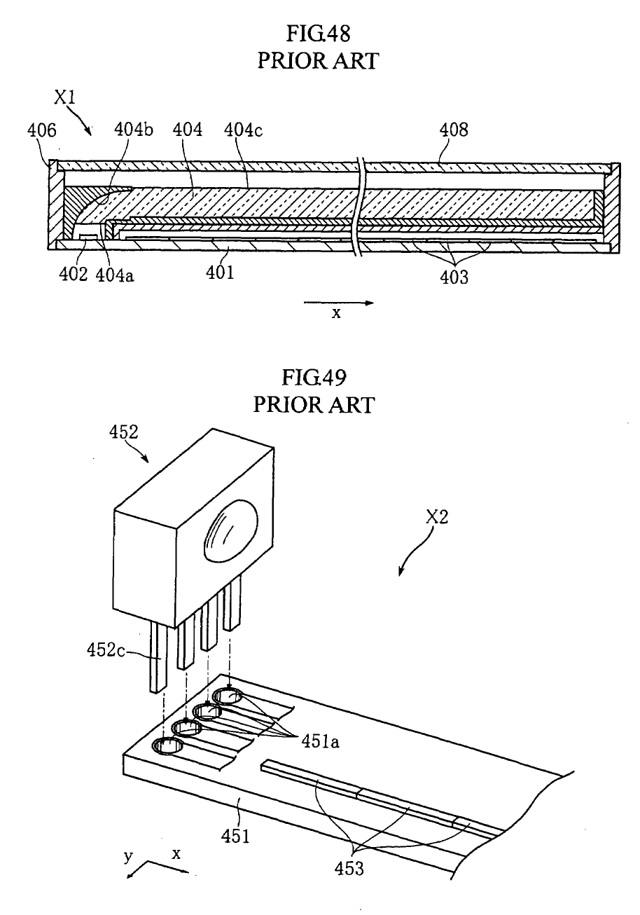

In this embodiment, the attenuation of light due to the unnecessary reflection of light as described with reference to FIG. 48 does not occur. Therefore, the luminance of the linear light is enhanced. Since the three LEDs 21 are arranged along the optical axis of the light guide 4, the luminance of the light within the light guide 4 and that of the linear light emitted from the light emitting surface 4c is made uniform. By making the luminance of the linear light high and uniform, a clear image can be obtained.

All of the LED chips 21 shown in FIG. 1 are mounted directly on the pads 15a of the shorter substrate 12. Thus, the heat transfer from the LED chips 21 to the shorter substrate 12 is good. Accordingly, the heat from the LED chips 21 readily escapes to the shorter substrate 12. Therefore, it is possible to supply high electric power to the LED chips 21 to increase the luminance. The shorter substrate 12 made of a ceramic material has a relatively high thermal conductivity, which is advantageous for promoting the dissipation of heat from the LED chips 21.

The longer substrate 11 and the shorter substrate 12 are connected to each other via the flexible wiring substrate 13. With the use of the flexible wiring substrate 13 having a high flexibility, the longer substrate 11 and the shorter substrate 12, which are arranged perpendicularly, are electrically connected to each other properly. Further, since the non-bond portion 13b is provided in the flexible wiring substrate 13, the non-bond portion 13b is flexed selectively. Therefore, the bond portions 13a of the flexible wiring substrate 13 are prevented from unduly separating from the substrate 1.

The light emitted from the LED chips 21 in the in-plane direction of the shorter substrate 12 is reflected at the reflecting surface 22a of the reflector 22 toward the light incident surface 4a. Since the reflector 22 is made of white resin, the reflecting surface 22a has high reflectivity. Further, the lens surface 23a of the light transmitting member 23 enhances the directivity of the light from the LED chips 21. Therefore, a large amount of light emitted from the LED chips 21 impinges on the light incident surface 4a.

By bringing the shorter substrate 12 into contact with the reference wall 61 of the case 6, the shorter substrate 12 is positioned properly relative to the case 6 in the primary scanning direction x. Therefore, the LED chips 21 are also positioned properly in the primary scanning direction x. The fixation of the substrate assembly 1 using the light shielding film 9 is relatively easy, whereby the time required for the manufacturing is shortened. Further, light is prevented from unduly leaking through a clearance between the shorter substrate 12 and the case 6 and a clearance between the longer substrate 11 and the shorter substrate 12.

FIGS. 15-19 show variations of the first embodiment. In these figures, the elements which are identical or similar to those of the first embodiment are designated by the same reference signs as those used for the first embodiment.

FIG. 15 shows a first variation of the image sensor module A1. The illustrated image sensor module A2 differs from the first embodiment in structure of the light source 2 and the light guide 4. In this variation, although the light source 2 includes three LED chips 21, the reflector 22 and the light transmitting member 23 as shown in FIG. 3 are not provided. Further, an end of the light guide 4A is formed with a recess, and the inner surface of the recess serves as the light incident surface 4a. The space defined in the recess has a size capable of accommodating three LED chips 21. The light guide 4 is held in engagement with the shorter substrate 12 of the substrate assembly 1.

With this structure, all the light emitted from the three LED chips 21 is introduced into the light guide 4 without reflection. Since the reflector 22 and the light transmitting member 23 do not need to be prepared, the time required for the manufacturing and the manufacturing cost are advantageously reduced.

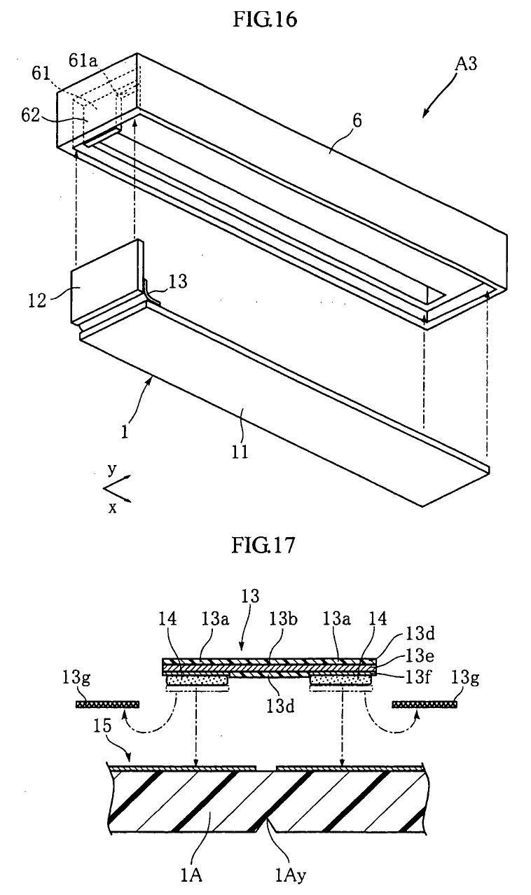

FIG. 16 shows a second variation of the image sensor module A1. The illustrated image sensor module A3 differs from the foregoing embodiments in shape of the case 6 and manner in which the substrate assembly 1 is mounted to the case 6. In this variation, the case 6 includes an outer wall 62 facing the reference wall 61. The opening 61a opens downward from the reference wall 61. The substrate assembly 1 is mounted to the case 6 by inserting the shorter substrate 12 into the space between the reference wall 61 and the outer wall 62. In this mounting step, the light source 2 enters the opening 61a from below. Further, a light shielding film 9 shown in FIG. 4 may be attached to both the outer wall 62 and the longer substrate 11. With this structure again, the substrate assembly 1 including the longer substrate 11 and the shorter substrate 12 is properly mounted to the case 6. Since the outer wall 62 is provided at the end of the case 6 in the primary scanning direction x, the light from the light source 2 is prevented from leaking.

FIG. 17 shows another example of flexible wiring substrate 13 used for the above-described image sensor module A1. In the illustrated printed wiring substrate 13, anisotropic conductive films 14 are provided at the lower surface of the bond portions 13a in advance. The printed wiring substrate 13 includes two resin layers 13d made of e.g. polyimide, polyester or resist, and a metal layer 13e sandwiched between the resin layers. The lower surface of the metal layer 13e includes portions which are not covered by the lower resin layer 13d, and plating layers 13f are formed on the portions. The anisotropic conductive films 14 are bonded to the plating layers 13f. Release sheets 13g are provided to prevent unintentional adhesion of the anisotropic conductive films 14 in handling the printed wiring substrate 13.

To attach the flexible wiring substrate 13 having this structure to the substrate material 1A, the release sheets 13g are removed to expose the anisotropic conductive films 14. Then, the flexible wiring substrate 13 is placed on the substrate material 1A so that the anisotropic conductive films 14 are positioned on opposite sides of the groove 1Ay. Then, by applying pressure and heat to the flexible substrate 13, the flexible wiring substrate 13 is bonded to the substrate material 1A via the anisotropic conductive films 14. With this structure, the process step of attaching the anisotropic conductive films 14 alone is unnecessary, and the printed wiring substrate 13 and the anisotropic conductive films 14 are collectively attached to the substrate material. This is advantageous for shortening the time required for the manufacturing.

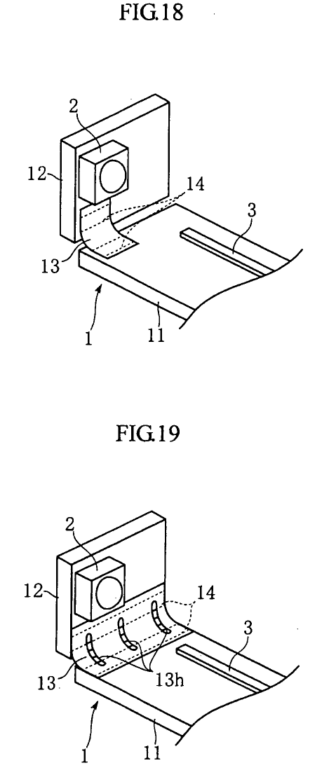

FIGS. 18 and 19 show other examples of flexible wiring substrate 13. Unlike the flexible wiring substrate shown in FIG. 11, the width of the flexible wiring substrate 13 shown in FIG. 18 is considerably smaller than that of the substrate assembly 1. With this structure, the flexible wiring substrate 13 is easily deformable to be twisted. Therefore, twisted positional relationship may be established between the longer substrate 11 and the shorter substrate 12 to facilitate the mounting of the substrate assembly to the case 6. The printed wiring board 13 shown in FIG. 19 is formed with a plurality of slits 13h. The slits 13h extend in the direction in which the longer substrate 11 and the shorter substrate 12 are connected to each other. This structure also facilitates the mounting of the substrate assembly 1 to the case 6.

Although the above-described image sensor module A1 is of a sheet feed type, the present invention is not limited thereto. For example, the image sensor module may be so designed that the image sensor module itself scans in the secondary scanning direction y to read the document placed on a fixed transparent plate (so-called flatbed type). The light emitting surface 4c of the light guide 4 is not limited to a curved surface but may be a flat surface.

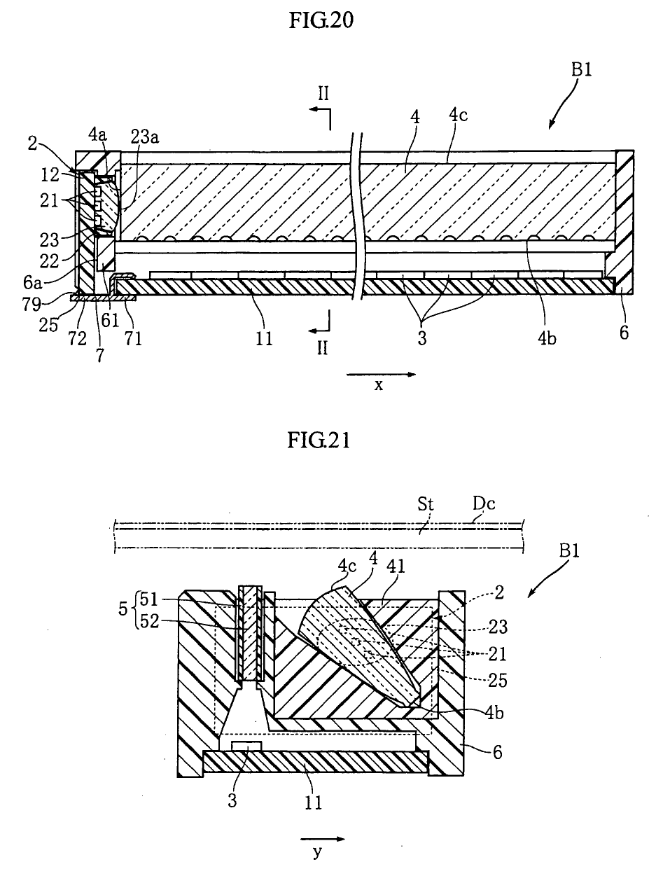

FIGS. 20-23 show an image sensor module B1 according to a second embodiment of the present invention. The image sensor module B1 includes a longer substrate 11, a light source 2, a plurality of sensor IC chips 3, a light guide 4, a lens array 5 and a case 6. For example, relative to the document Dc placed on a document support panel St as shown in FIG. 21, the image sensor module B1 moves in the secondary scanning direction y to read the content of the document Dc as the image data.

The longer substrate 11 is made of a ceramic material such as alumina or aluminum nitride and in the form of a rectangle elongated in the primary scanning direction x. A plurality of sensor IC chips 3 are mounted on the longer substrate 11 along the primary scanning direction x. A plurality of leads 7 are mounted to an end of the longer substrate 11 in the primary scanning direction x. The longer substrate 11 is mounted to the lower end of the case 6 and properly positioned relative to the case 6.

As shown in FIGS. 20 or 23, the light source 2 includes a shorter substrate 12, three LED chips 21, a reflector 22 and a light transmitting member 23. The shorter substrate 12 may be made of glass-fiber-reinforced epoxy resin or a composite material of a reinforcing member and polyimide resin.

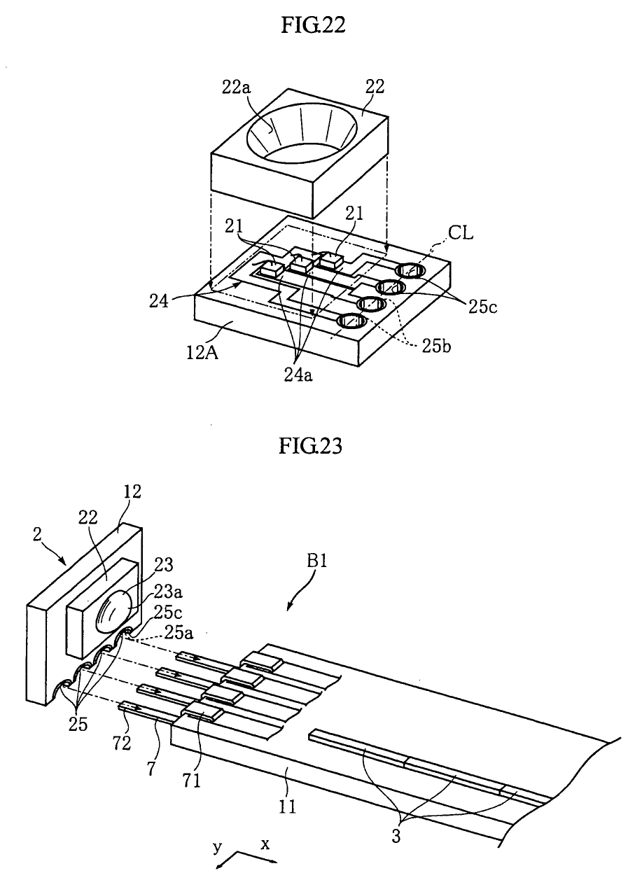

FIG. 22 shows a process step of a method for manufacturing the light source 2. As shown in the figure, three LED chips 21 are mounted on pads 24a of a wiring pattern 24 of a substrate material 12A. Then, a reflector 22 is mounted on the substrate material 12A to accommodate the three LED chips 21. Then, by loading e.g. epoxy resin into a through-hole of the reflector 22, a light transmitting member 23 is formed. Similarly to the first embodiment, the reflector 22 may be made of white resin and include a reflecting surface 22a flared in the light emission direction. The light transmitting member 23 includes a lens surface 23a. The substrate material 12A is, in advance, formed with a plurality of through-holes 25b. A metal film 25c made of Cu or Au, for example, is formed on the inner surface of the through-holes 25b. The substrate material 12A is cut along the cutting line CL shown in the figure. As a result, as shown in FIG. 23, a plurality of terminals 25, each including a recess 25a which is semicircular in section and a metal film 25c covering the inner surface of the recess 25a, are formed at the lower edge of the shorter substrate 12.

The light guide 4, the spacer 41 and the lens array 5 of the second embodiment have the substantially same structure and function as those of the first embodiment.

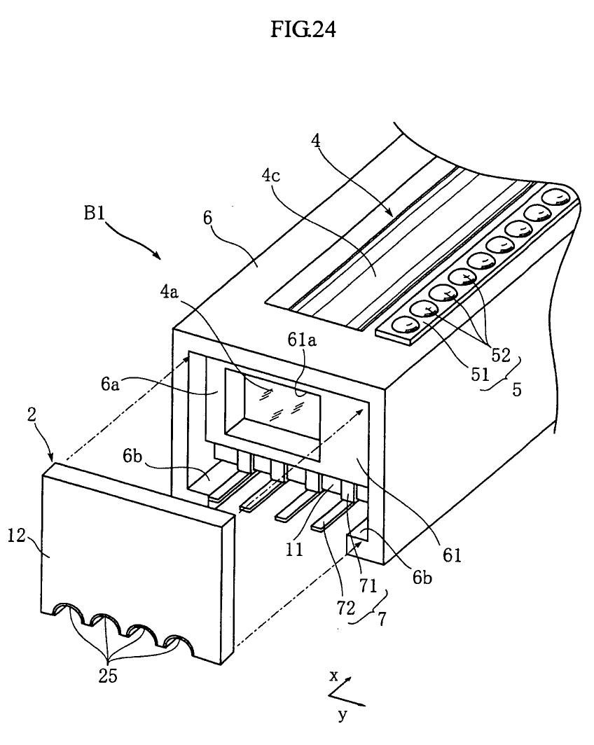

The case 6 shown in FIG. 24 is made of synthetic resin and generally in the form of a block extending in the primary scanning direction x. The case 6 accommodates the longer substrate 11, the light source 2, the sensor IC chips 3, the light guide 4 and the lens array 5. The case 6 includes a partition wall 61 positioned adjacent to the end thereof in the primary scanning direction x. The partition wall 61 is formed with an opening 61a. The opening 61a serves to accommodate e.g. the reflector 22 of the light source 2 to allow the light from the light source 2 to reach the light incident surface 4a of the light guide 4. Instead of the reflector 22, part of the light guide 4 may be accommodated in the opening 61a. Alternatively, neither the light source 2 nor the light guide 4 may be accommodated in the opening 61a, and the light from the light source 2 may just pass through the opening 61a. The case 6 includes positioning surfaces 6a and 6b. The positioning surface 6a is utilized for properly positioning the light source 2 relative to the case 6 in the primary scanning direction x. The positioning surface 6b is utilized for properly positioning the light source 2 relative to the case 6 in the direction which is perpendicular to both of the primary scanning direction x and the secondary scanning direction y. To fix the light source 2 to the longer substrate 11, the light source 2 is moved along the primary scanning direction x, and the movement is completed when the light source 2 comes into contact with the positioning surfaces 6a and 6b. In this state, the above-described soldering is performed, whereby the light source 2 is fixed.

As shown in FIG. 23, the plurality of leads 7 are utilized for fixing the light source 2 to the longer substrate 11. Each of the leads 7 may be made of Cu or Ni and includes a clip portion 71 and a straight portion 72. The clip portion 71 is formed at an end of the lead 7 and holds an end edge of the longer substrate 11. The clip portion 71 is electrically connected to the wiring pattern of the longer substrate 11. Each of the leads 7 is fixed to the longer substrate 11 by utilizing solder or resin (neither shown) in addition to the holding force of the clip portion 71. The straight portion 72 is provided at the end opposite from the clip portion 71 and projects in the longitudinal direction X. As shown in FIG. 20, the straight portion 72 is bonded to a terminal 25 formed at the shorter substrate 12 of the light source 2 with solder 79. To mount the plurality of leads 7 to the longer substrate 11, a frame (not shown) including a plurality of leads 7 connected in parallel with each other is prepared. Then, with the clip portions 71 of the leads 7 collectively holding the longer substrate 11, the frame is cut. Then, as shown in FIG. 23, the light source 2 is moved toward the leads 7 along the primary scanning direction X. Then, the terminals 25 and the straight portions 72 are soldered together, whereby the light source 2 is fixed to the longer substrate 11.

The advantages of the image sensor module B1 will be described below.

According to the present invention, a hole for fixing a lead 7 to the longer substrate 11 does not need to be formed at the longer substrate 11. Therefore, it is possible to use a ceramic material as the material of the longer substrate 11. The longer substrate 11 made of a ceramic material is advantageous for dissipating heat generated during the operation of the image sensor module B1 to the outside. Moreover, deformation of the substrate due to heat is unlikely to occur, so that an error in reading is reduced.

Further, according to the present invention, the longer substrate 11 and the shorter substrate 12 are easily and reliably connected to each other by the leads 7. The fixation of the leads 7 to the longer substrate 11 is performed just by e.g. preparing a lead frame including a plurality of leads connected to each other and pushing the clip portions 71 of the lead frame against the substrate 1. In fixing the shorter substrate 12 to the leads 7, it is only necessary to set the terminals 25 to the straight portions 72 of the leads 7, and it is not necessary to accurately position the terminals 25 relative to the straight portions 72.

The light source 2 and the light guide 4 are accurately positioned relative to each other by utilizing the positioning surfaces 6a and 6b of the case 6. The work for bringing the light source 2 into contact with the positioning surfaces 6a and 6b can be performed simultaneously with the work for setting the terminals 25 of the shorter substrate 12 to the straight portions 72.

The shorter substrate 12 made of e.g. glass-fiber-reinforced epoxy resin can be prepared at a relatively low cost. The arrangement of the LED chips 21 on the shorter substrate 12 is easily changeable by changing the configuration of the wiring pattern 24. Unlike the present invention, when use is made of a light source provided with a resin package molded using a die, a different die needs to be prepared to change the arrangement of the LED chips. According to this embodiment, however, the structure of the light source 2 is easily changeable in accordance with the specification of the scanner for which the image sensor module B1 is used.

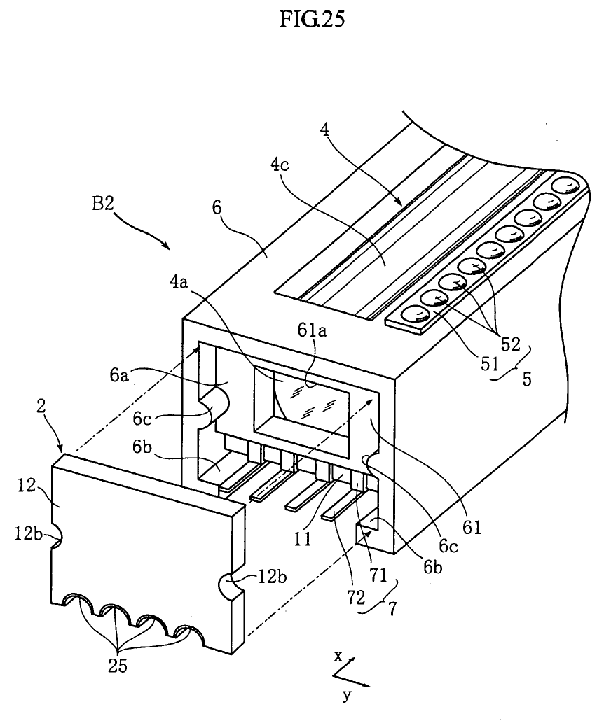

Referring to FIGS. 25-29, four variations of the second embodiment will be described below.

FIG. 25 shows a first variation. The image sensor module B2 of this variation is characterized in that the case 6 is formed with a pair of projections 6c and that the shorter substrate 12 is formed with a pair of recesses 12b. By fitting the paired projections 6c and the paired recesses 12b to each other, the light source 2 is positioned accurately relative to the case 6.

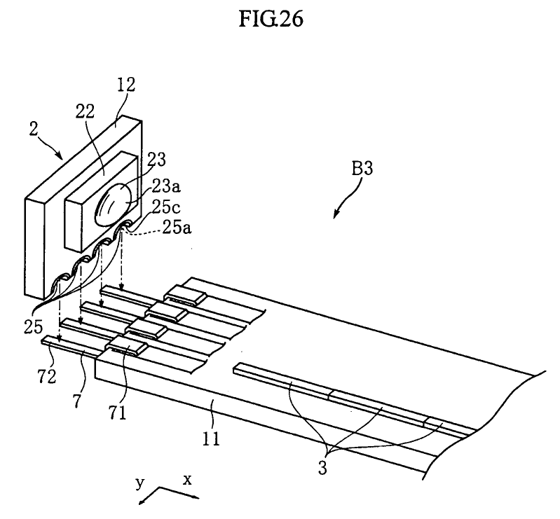

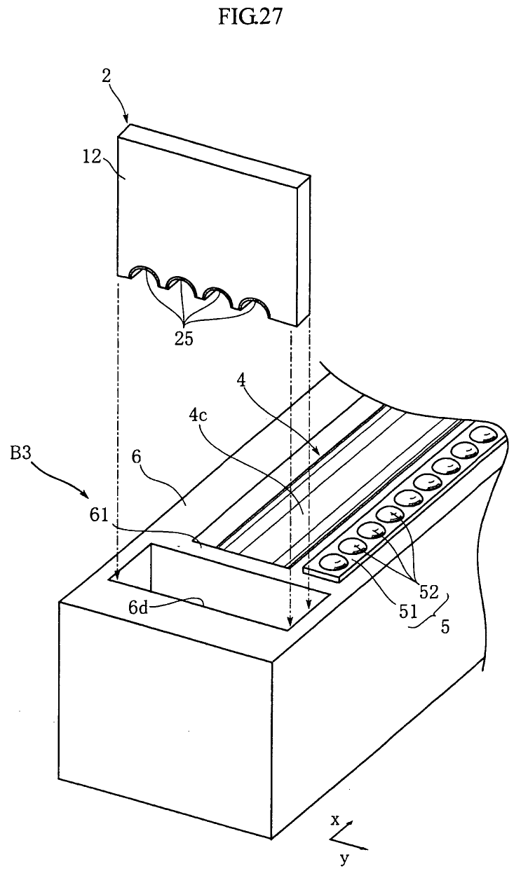

FIGS. 26 and 27 show a second variation. In FIG. 26, the illustration of the light guide 4 and the case 6 are omitted. The image sensor module B3 differs from the foregoing embodiments in direction in which the light source 2 is moved in mounting the light source 2 to the leads 7. In this variation, the light source 2 is moved in the direction which is perpendicular to both of the primary scanning direction x and the secondary scanning direction y. Each of the terminals 25 formed at the shorter substrate 12 is semicircular in section. The case 6 is formed with an opening 6d which opens in the direction which is perpendicular to both of the primary scanning direction x and the secondary scanning direction y. By inserting the light source 2 into the opening 6d, the light source 2 is properly positioned relative to the case 6.

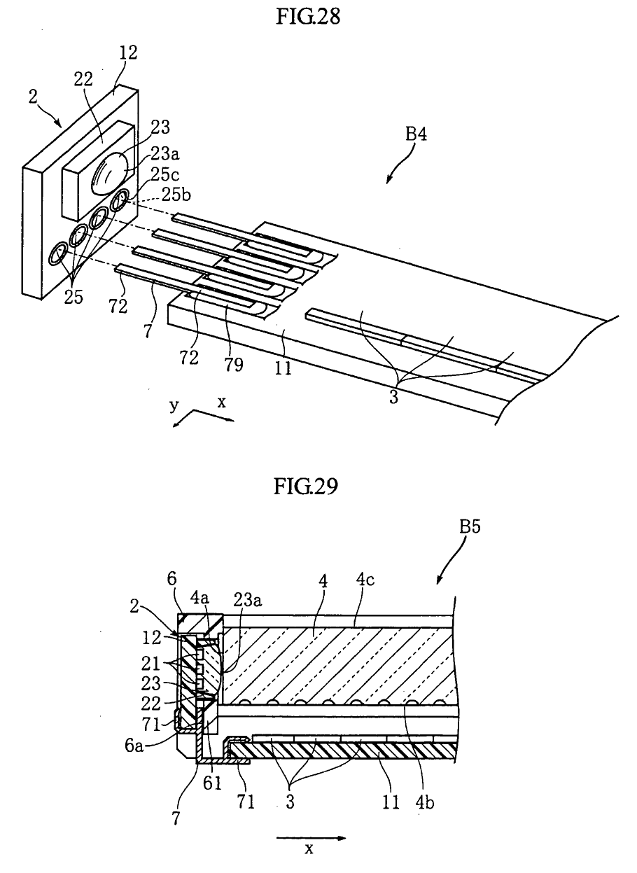

FIG. 28 shows a third variation. The image sensor module B4 differs from the foregoing embodiments in structure of the terminals 25 and manner in which the leads 7 are fixed to the longer substrate 11. In this variation, the terminals 25 comprise through-holes formed at the shorter substrate 12. Each of the leads 7 includes two straight portions 72. One of the straight portions 72 is bonded to the wiring pattern of the longer substrate 11 via solder 79, whereas the other straight portion 72 is inserted into the terminal 25. With this structure again, the longer substrate 11 and the shorter substrate 12 are connected to each other easily and reliably.

FIG. 29 shows a fourth variation. The image sensor module B5 of this variation differs from the foregoing embodiments in that each of the leads 7 is formed with two clip portions 71. In this variation, not only the longer substrate 11 but also the shorter substrate 12 is held by the clip portions 71. This fixation using the clip portions 71 is suitable for separating the light source 2 and the longer substrate 11 from each other to check defects, for example, after the image sensor module B5 is assembled. Since the separation is easy, the work for checking defects is performed efficiently.

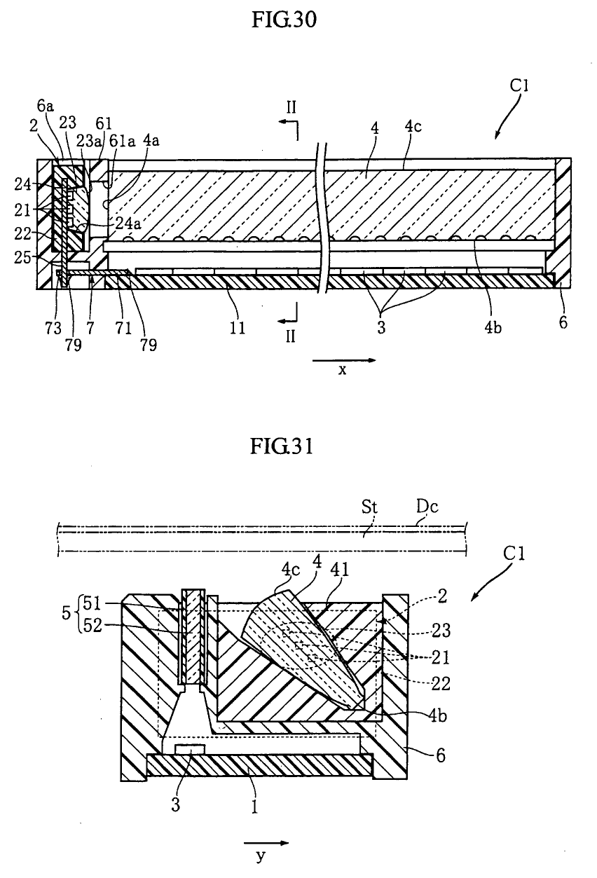

FIGS. 30 and 31 show an image sensor module C1 according to a third embodiment of the present invention. The image sensor module C1 includes a longer substrate 11, a light source 2, a plurality of sensor IC chips 3, a light guide 4, a lens array 5 and a case 6. Similarly to the second embodiment, relative to the document Dc placed on a document support panel St, the image sensor module C1 moves in the secondary scanning direction y to read the content of the document Dc as the image data.

The longer substrate 11 is made of a ceramic material such as alumina or aluminum nitride and in the form of a rectangle elongated in the primary scanning direction x. The sensor IC chips 3 are mounted on the longer substrate 11 along the primary scanning direction x. A plurality of leads 7 are attached to an end of the longer substrate 11 in the primary scanning direction x. The longer substrate 11 is mounted to the lower end of the case 6 and properly positioned relative to the case 6.

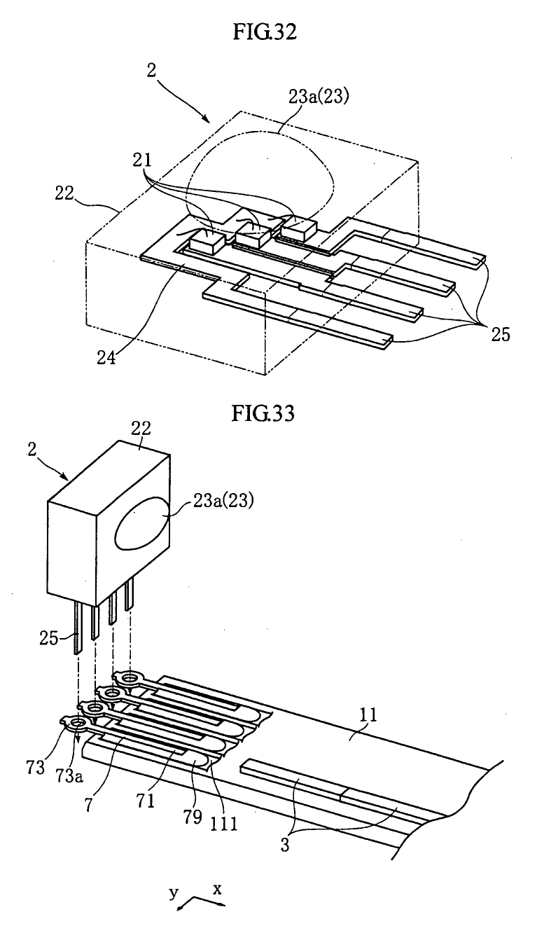

As shown in FIG. 32, the light source 2 includes three LED chips 21, a resin package 22, a light transmitting member 23 and a lead frame 24. The lead frame 24 includes a plurality of strips made of Cu or Ni. The portions of the lead frame 24 which project from the resin package 22 serve as terminals 25. The three LED chips 21 may emit red light, green light and blue light, respectively, and are bonded to the lead frame 24. As shown in FIG. 31, the LED chips 21 are arranged in series along the light emission direction of the light guide 4.

As shown in FIG. 30, the resin package 22, which may be made of white resin, covers part of the lead frame 24 and surrounds the three LED chips 21. The resin package 22 includes a reflecting surface 22a which is flared in the primary scanning direction x. Part of the light emitted from the three LED chips 21 is reflected by the reflecting surface 22a toward the primary scanning direction x. The light transmitting member 23 may be made of transparent epoxy resin and fills the region surrounded by the resin package 22. The light transmitting member 23 includes a lens surface 23a. The lens surface 23a enhances the directivity of the light emitted from the three LED chips 21.

The leads 7 shown in FIG. 33 are utilized for fixing the light source 2 to the longer substrate 11. This figure shows a process step of a method for manufacturing the image sensor module C1. As shown in the figure, each of the leads 7, which may be made of Cu or Ni, includes a straight portion 71 and a ring-shaped portion 73. The straight portion 71 is provided at an end of the lead 7 and bonded to the wiring pattern 111 of the longer substrate 11 with solder 79. Instead of the solder 79, the straight portion 71 may be bonded using resin. The ring-shaped portion 73 is formed at the end opposite from the straight portion 71 and projects from the longer substrate 11 in the primary scanning direction x. Each of the terminals 25 of the light source 2 is inserted into a respective one of the ring-shaped portions 73. As shown in FIG. 30, the terminal 25 and the inner circumferential surface 73a and so on of the ring-shaped portion 73 are bonded to each other with solder 79.

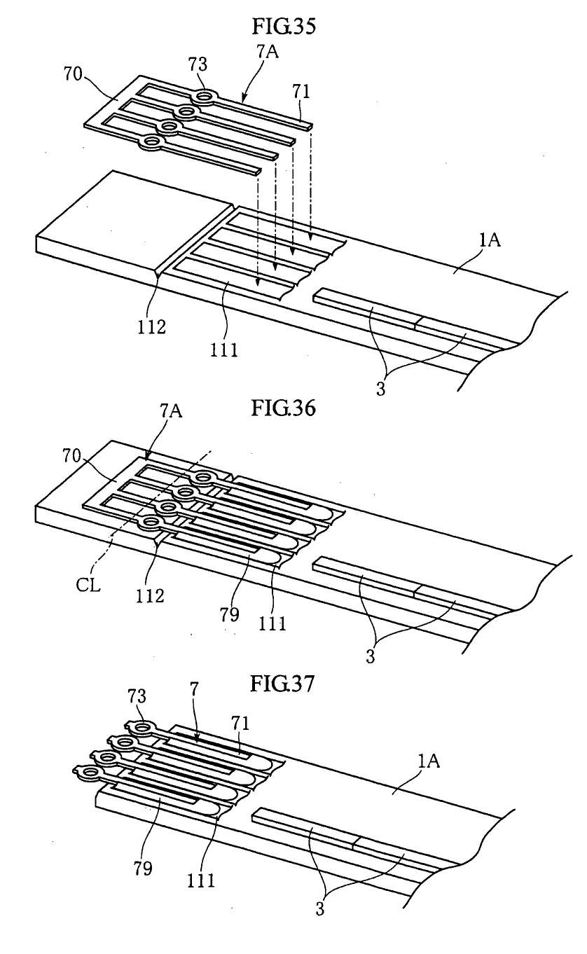

FIGS. 35-37 show the process steps of forming and attaching the leads 7. As shown in FIG. 35, a substrate material 1A formed with a groove 112 is prepared, and a lead frame 7A is placed on the substrate material 1A. The groove 112 may be formed by irradiating the substrate material 1A with a laser beam to form a plurality of non-through holes. The lead frame 7A includes a plurality of straight portions 71 and ring-shaped portions 73 which are connected to each other via a frame portion 70. The straight portions 71 are soldered to the wiring pattern 111. Then, as shown in FIG. 36, the substrate material 1A is bent along the groove 112 so that the substrate material 1A is cut. Then, the lead frame 7A is cut along the cutting line CL. As a result, four leads 7 as shown in FIG. 37 are obtained from the lead frame 7A. The four leads 7 are in a state fixed to the longer substrate 11.

The light guide 4, the spacer 41 and the lens array 5 of the third embodiment have the substantially same structure and function as those of the first or the second embodiment.

As shown in FIG. 30, the case 6 is made of synthetic resin and generally in the form of a block extending in the primary scanning direction x. The case 6 accommodates the longer substrate 11, the light source 2, the sensor IC chips 3, the light guide 4 and the lens array 5. The case 6 includes a partition wall 61 positioned adjacent to an end thereof in the primary scanning direction x. The partition wall 61 is formed with an opening 61a. The opening 61a serves to pass the light from the light source 2 so that the light impinges on the light incident surface 4a of the light guide 4.

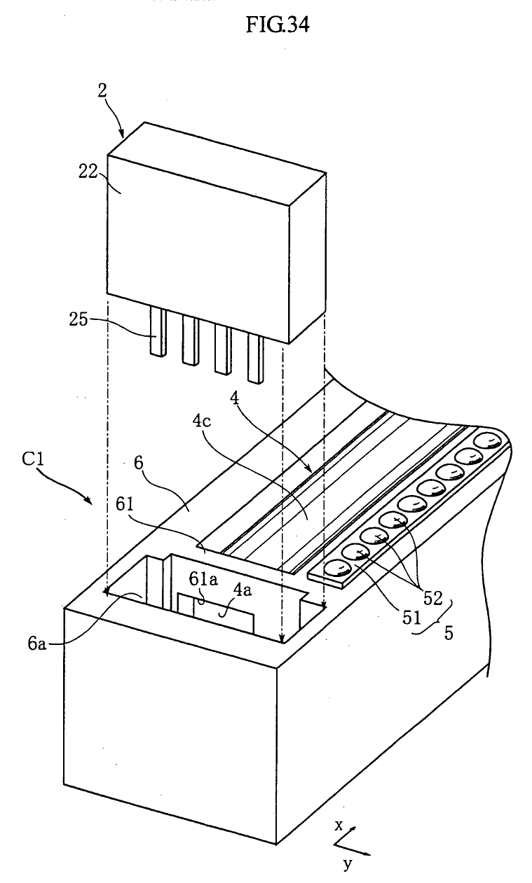

As shown in FIG. 34, the case 6 includes a space 6a. The space 6a opens in the vertical direction (which is perpendicular to both of the primary scanning direction x and the secondary scanning direction y) and accommodates the light source 2. The space 6a has a shape for fitting to the resin package 24. Therefore, by inserting the light source 2 into the space 6a, the light source 2 is properly positioned easily relative to the case 6 in both of the primary scanning direction x and the secondary scanning direction y.

The advantages of the image sensor module C1 will be described below.

According to this embodiment, a hole for fixing a lead 7 to the longer substrate 11 does not need to be formed in the longer substrate 11. Therefore, the longer substrate 11 is prevented from cracking. Further, the material of the longer substrate 11 is not limited to those which are unlikely to crack. Therefore, like this embodiment, it is possible to use ceramic as the material of the longer substrate 11, which is advantageous for properly dissipating heat generated during the use of the image sensor module C1 to the outside. Further, the longer substrate 11 made of ceramic is unlikely to be deformed due to heat, which is advantageous for reducing a reading error of the image sensor module C1.

Since soldering is performed with the terminals 25 inserted into the ring-shaped portions 73 of the leads 7, the terminals 25 are prevented from largely separating from the ring-shaped portions 73. The soldering work is relatively easy, so that the longer substrate 11 and the light source 2 are fixed to each other easily and reliably. Further, by fitting the light source 2 into the space 6a of the case 6, the light source 2 is properly positioned relative to the light guide 4.

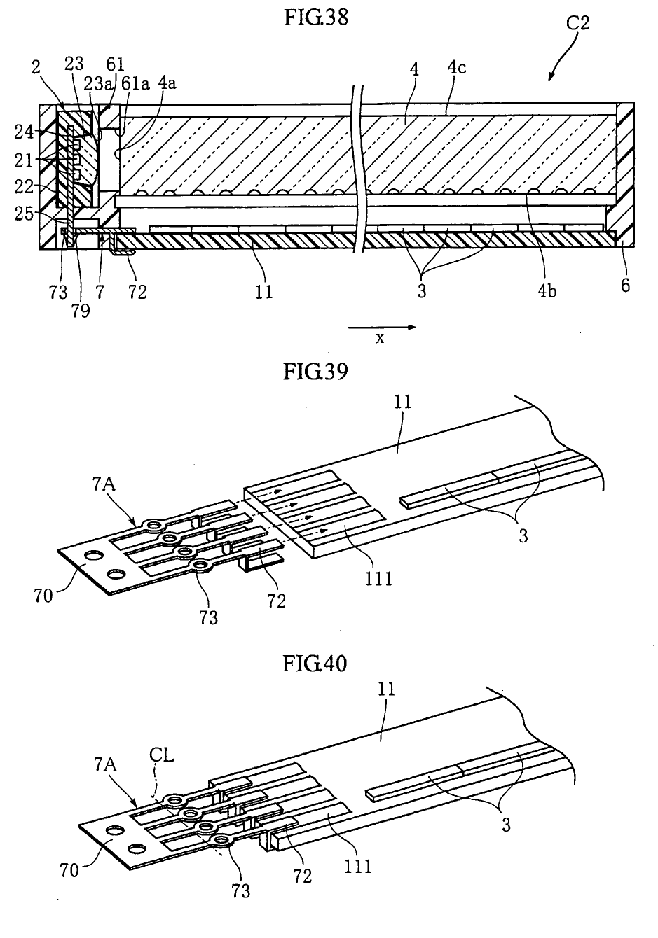

FIGS. 38-47 show variations of the third embodiment.

FIG. 38 shows a first variation. The image sensor module C2 of this variation differs from the above-described ones in structure of the leads 7 and manner in which the leads 7 are fixed to the longer substrate 11. In this variation, each of the leads 7 includes a clip portion 72 at an end thereof. The clip portion 72 holds an end of the longer substrate 11, whereby the lead 7 and the longer substrate 11 are fixed to each other.

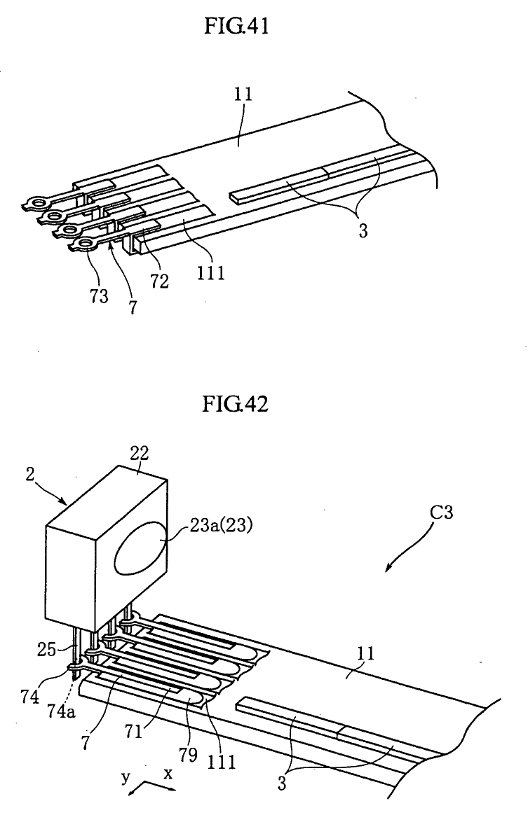

FIGS. 39-41 show process steps of a method for manufacturing the image sensor module C2. FIG. 39 shows the process step of attaching a lead frame 7A to the longer substrate 11. The lead frame 7A includes a plurality of ring-shaped portions 73 and clip portions 72 which are connected to each other via a frame portion 70. By pushing the clip portions 72 against the longer substrate 11, the lead frame 7 is attached to the longer substrate 11. Then, as shown in FIG. 40, the lead frame 7A is cut along the cutting line CL. As a result, four leads 7 are obtained, as shown in FIG. 41. The clip portion 72 of each of the four leads 7 holds the longer substrate 11.

With the above-described variation again, the light source 2 is easily and reliably fixed to the longer substrate 11. Since the light source 2 is fixed to the longer substrate 11 by utilizing the holding force of the clip portion 72 for holding the longer substrate 11, the light source 2 is firmly fixed to the longer substrate 11. In addition to the holding force of the clip portion 72, solder or resin may be applied to reinforce the fixation of the lead 7.

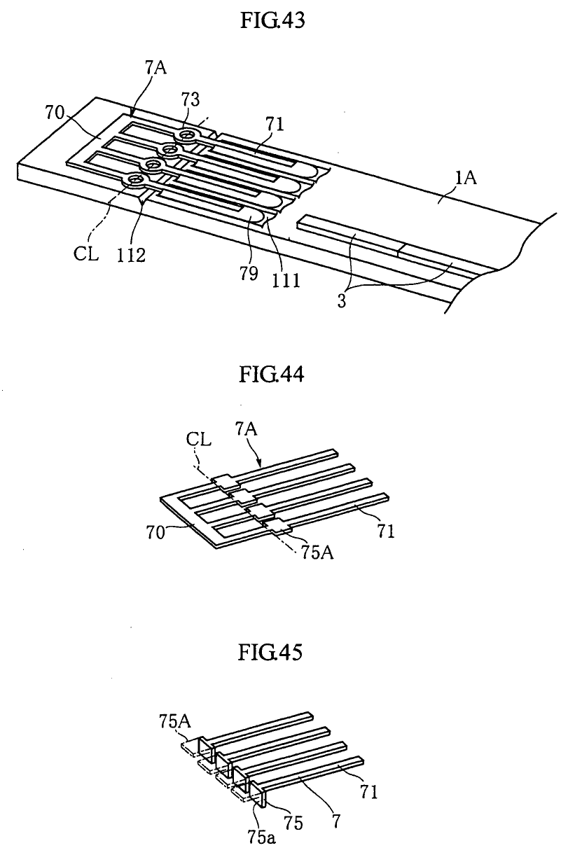

FIG. 42 shows a second variation. The image sensor module C3 of this variation differs from the above-described variation in structure of the leads 7. In this figure, the illustration of the light guide 4, the lens array 5 and the case 6 is omitted. In this variation, each of the leads 7 includes a U-shaped portion 74 at an end thereof. The terminal 25 is fitted to the inner surface of the U-shaped portion 74 and soldered in this state. The lead 7 having this structure is prepared and fixed to the longer substrate 11 by the process steps similar to those described above with reference to FIGS. 35-37. As shown in FIG. 43, after the lead frame 7A is bonded to the substrate material 1A, the lead frame 7A is cut along the cutting line CL to divide the ring-shaped portions 73. As a result, the ring-shaped portions 73 are divided, and the U-shaped portions 74 shown in FIG. 42 are obtained.

In manufacturing the image sensor module C3, instead of moving the light source 2 toward the leads 7 on the longer substrate 11 in a direction which is perpendicular to both of the primary scanning direction x and the secondary scanning direction y, the light source 2 can be moved toward the leads 7 along the primary scanning direction x. Therefore, the image sensor module C3 can employ a case 6 having an opening which opens in the primary scanning direction x to fit to the resin package 24 of the light source 2.

As another example of lead, a lead including a T-shaped portion at an end thereof may be employed. As shown in FIG. 44, a lead frame 7A is prepared which includes a plurality of rectangular portions 75A and straight portions 71 which are connected to each other via a frame portion 70. After the lead frame 7A is cut along the cutting line CL, each of the rectangular portions 75A is bent downward. As a result, as shown in FIG. 45, leads 7 each including a T-shaped portion 75 are obtained. To bond terminals 25 to the leads 7, soldering is performed with the terminals 25 arranged in front of the side surfaces 75a of the T-shaped portions 75. With this embodiment again, the light source 2 is easily and reliably fixed to the longer substrate 11.

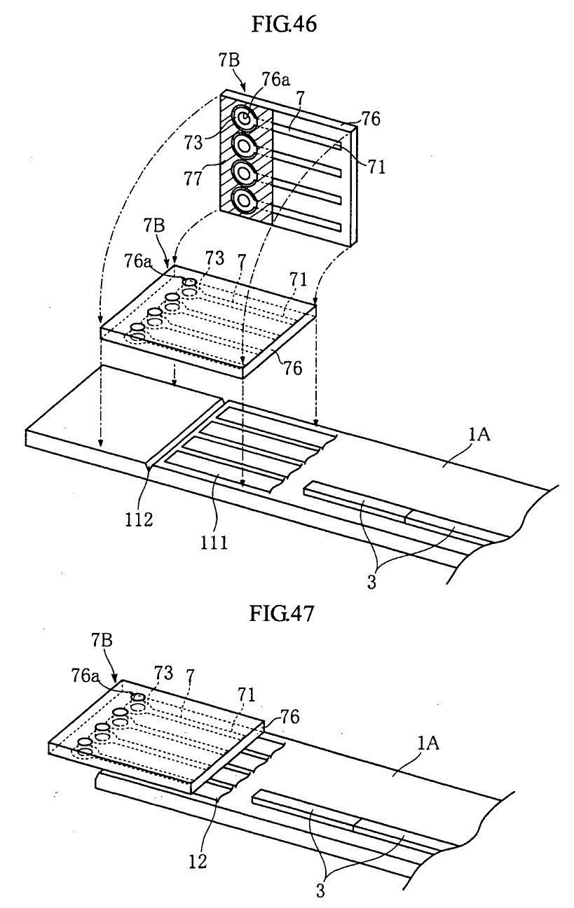

As another example of lead, a plurality of leads connected to each other by a base member may be used. In the example shown in FIG. 46, a printed wiring board 7B is used. The printed wiring board 7B includes a base member 76 made of glass-fiber-reinforced epoxy resin or polyimide resin and a plurality of leads 7 formed on the base member by printing or patterning. The base member 76 is formed with a plurality of through-holes 76a. The through-holes 76a correspond to the holes of the ring-shaped portions 73 of the leads 7. Each of the leads 7 is partially covered by a resist film 77. The resist film 77 is formed with a plurality of holes, and the ring-shaped portions 73 are exposed through the holes. Straight portions 71 are exposed and extend from an edge of the resist film 77. The printed wiring board 7B is mounted to the substrate material 1A by using e.g. solder or conductive resin. After the straight portions 71 are bonded to the wiring pattern 111, the substrate material 1A is cut along the groove 112. As a result, as shown in FIG. 47, the printed wiring board 7B is attached to the longer substrate 11, with the portion formed with the ring-shaped portions 73 projecting from the substrate 1. With this structure again, the light source 2 is easily and reliably fixed to the longer substrate 11. The positional relationship between the leads 7 formed on the base member 76 is accurate.

The clip portion in the present invention may have any shape as long as it is suitable for holding the substrate and is not limited to the shape described above. Of the lead 7, the portion to which the terminal 25 is to be bonded is not limited to the ring-shaped portion 73, the U-shaped portion 74 and the T-shaped portion 75, and may have any shape which is suitable for bonding the terminal 22 by e.g. soldering.

1. An image sensor module comprising:
a first substrate extending in a primary scanning direction;
a second substrate including a main surface;
a plurality of light receiving elements mounted on the first substrate in a row extending in the primary scanning direction;
a light source mounted-on the main surface of the second substrate; and
a light guide for emitting light from the light source as linear light extending in the primary scanning direction;
wherein the main surface of the second substrate is oriented in the primary scanning direction, and wherein the light source includes an LED chip mounted on the second substrate.

2. The image sensor module according to claim 1, wherein the first substrate and the second substrate are connected to each other via a conductive support member having flexibility.

3. The image sensor module according to claim 2, wherein the first substrate has an end close to the second substrate and the second substrate has an end close to the first substrate, the ends being not bonded to the conductive support member.

4. The image sensor module according to claim 1, wherein at least one of the first substrate and the second substrate is made of ceramic.

5. The image sensor module according to claim 1, wherein the light source includes a reflector surrounding the LED chip.

6. The image sensor module according to claim 5, wherein the reflector is made of white resin.

7. The image sensor module according to claim 5, wherein the light source includes a light transmitting member covering the LED chip.

8. The image sensor module according to claim 1, wherein the light guide is formed, at a portion facing the second substrate, with a recess for accommodating the LED chip.

9. The image sensor module according to claim 1, further comprising a case for accommodating the first substrate, the second substrate and the light guide, wherein the case is formed with a reference wall including a surface oriented in the primary scanning direction, and wherein the second substrate is held in contact with the reference wall.

10. The image sensor module according to claim 9, further comprising a light shielding member attached to both the case and a surface of the second substrate which is opposite from the main surface.

11. The image sensor module according to claim 10, wherein the light shielding member is attached to both the second substrate and the first substrate.

12. A method for manufacturing an image sensor module including a light source and a plurality of light receiving elements arranged in a primary scanning direction, the method comprising the steps of:
attaching a flexible conductive support member to a substrate in a manner such that the conductive support member extends across a division target portion extending in a secondary scanning direction perpendicular to the primary scanning direction; and
dividing the substrate at the division target portion to obtain a first substrate on which the light receiving elements are mounted and a second substrate on which the light source is mounted.

13. The method according to claim 12, further comprising the step of directly mounting an LED chip providing the light source on the substrate.

14. The method according to claim 13, wherein the substrate is made of ceramic.

15. The method according to claim 12, wherein the step of attaching the conductive support member includes attaching two anisotropic conductive films to the substrate in parallel with each other on opposite sides of the division target portion, and attaching the conductive support member to the substrate by utilizing the anisotropic conductive films.

16. The method according to claim 12, further comprising the step of mounting the first substrate and the second substrate to a case extending in the primary scanning direction, wherein the case is formed with a reference wall including a surface oriented in the primary scanning direction, and wherein the mounting step comprises bringing the second substrate into contact with the reference wall.

17. The method according to claim 16, wherein the mounting step comprises attaching a light shielding member to both the second substrate and the case.

18. An image sensor module comprising:
a first substrate extending in a primary scanning direction and including opposite ends spaced from each other in the primary scanning direction;
a light source;
a light guide extending in the primary scanning direction and including a light incident surface facing the light source and a light emitting surface from which light introduced into the light guide through the light incident surface is emitted toward an object to be read as linear light extending in the primary scanning direction; and
light receiving sensors arranged on the first substrate along the primary scanning direction for receiving light reflected at the object to be read;
wherein the light source includes a second substrate and a light emitting element mounted on the second substrate, and wherein the second substrate and the first substrate are fixed to each other via a lead.

19. The image sensor module according to claim 18, wherein the lead includes a first end formed with a clip portion, and wherein one of the opposite ends of the first substrate is held by the clip portion.

20. The image sensor module according to claim 19, wherein the lead includes a second end which is straight and positioned opposite from the first end, wherein the second substrate includes a terminal provided at an edge thereof, the terminal comprising a recess formed at the edge and a metal film covering an inner surface of the recess, and wherein the second end of the lead is bonded to the terminal.

21. The image sensor module according to claim 18, wherein the second substrate is made of a material containing either of glass-fiber-reinforced epoxy resin and polyimide resin.

22. The image sensor module according to claim 18, wherein the light emitting element comprises an LED chip die-bonded to the second substrate.

23. The image sensor module according to claim 18, wherein the first substrate is made of ceramic.

24. The image sensor module according to claim 18, further comprising a case for accommodating the first substrate, the second substrate and the light guide, wherein the case includes a positioning surface for properly positioning the light source in the primary scanning direction and in a direction which is perpendicular to the primary scanning direction.

25. An image sensor module comprising:
a first substrate which is in the form of an elongated rectangle extending in a primary scanning direction;
a light source;
a light guide extending in the primary scanning direction and including a light incident surface facing the light source and a light emitting surface from which light introduced into the light guide through the light incident surface is emitted toward an object to be read as linear light extending in the primary scanning direction, the object to be read being moved in a secondary scanning direction relative to the light guide; and
light receiving sensors arranged on the first substrate along the primary scanning direction for receiving light reflected at the object to be read;
wherein the light source includes a terminal including a portion extending in a direction which is perpendicular to both of the primary scanning direction and the secondary scanning direction; and
wherein a lead projecting in the primary scanning direction is fixed to the first substrate, and wherein the lead and the terminal of the light source are bonded to each other.

26. The image sensor module according to claim 25, wherein the lead includes a straight end soldered to the first substrate.

27. The image sensor module according to claim 25, wherein the lead includes a clip-shaped end for holding an end of the first substrate.

28. The image sensor module according to claim 25, wherein the lead includes a ring-shaped end for inserting the terminal of the light source.

29. The image sensor module according to claim 25, wherein the lead includes a bond end surface to which the terminal of the light source is to be bonded, and wherein the bond end surface is oriented in the primary scanning direction.

30. The image sensor module according to claim 25, wherein the first substrate is made of ceramic.

31. The image sensor module according to claim 25, wherein the lead comprises part of a wiring formed on a resin base.

32. The image sensor module according to claim 25, further comprising a case for accommodating the first substrate, the light source and the light guide, wherein the case includes a space which opens in a direction which is perpendicular to both of the primary scanning direction and the secondary scanning direction, and wherein the light source is accommodated in the space.
